(19) United States
(12) Patent Application Publication
(10) Pub. No.: US 2024/0125420 A1
(43) Pub. Date: Apr. 18, 2024

(54) LAUNCHER SYSTEM, APPARATUS AND METHOD FOR LAUNCHING GEL PIG TRAINS

(71) Applicant: CURAPIPE SYSTEM LTD., Kiryat Malachi (IL)

(72) Inventors: David Hercky, Raanana (IL); Hanan Keller, Omer (IL); Peter Paz, Har Adar (IL)

(21) Appl. No.: 18/277,079

(22) PCT Filed: Feb. 15, 2022
(86) PCT No.: PCT/IL2022/050179

§ 371 Date: Aug. 14, 2023

Related U.S. Application Data
(60) Provisional application No. 63/150,587, filed on Feb. 18, 2021.

(51) Int. Cl. F16L 55/46; F16L 1/26; F16L 55/1645; F16L 55/42

(52) U.S. Cl. CPC F16L 55/46; F16L 1/26; F16L 55/1645; F16L 55/42; F16L 55/38

(57) ABSTRACT

The present invention provides a launcher system, adapted for deployment at a remote site, the launcher system including a launcher apparatus and a launcher apparatus carrier module for transporting the launcher apparatus to the remote site, the launcher system being configured to launch a gel pig train into a pipeline network and to seal a leakage in the pipeline network at the remote site.

### FIELD OF THE INVENTION

The present invention relates generally to transportable units for bringing to sites of pipeline leakages, and more specifically to launching systems and units, adapted for local deployment to launch pig trains, used to seal a local leakage in a pipeline network.

### BACKGROUND OF THE INVENTION

Many liquids are transported via subterranean/underwater pipelines. When a leakage crack or hole forms in the pipeline, the liquid leaks therefrom. Often, it takes a long time to detect a leakage and yet longer to locate the leakage site. Oil, gas and water transportation are thus subject to tremendous losses due to pipeline leakage.

Several patent publications in the field include WO2008081441, which describes a method of repairing leakage in pipelines. However, there are still many types of pipeline leakages, which cannot be cured using the aforementioned prior art materials and methods. There thus remains an urgent need to develop systems and methods for curing pipeline leakages.

There is thus a need to maintain and seal subterranean/underwater pipelines quickly in situ. There is a further need for portable, transportable units, which can be used to deployed pig trains locally, after determining specific location(s) of pipeline leakages.

### SUMMARY OF THE INVENTION

It is an object of some aspects of the present invention to provide launcher systems, adapted for local deployment and use to launch a pig train into a pipeline network, the pig train configured to seal a local leakage in a pipeline network.

The pipeline network may be configured to hold any fluid, such as, but not limited to water, drinking water, gas, fuel, gasoline, natural gas and combinations thereof.

It is a further object of the present invention to provide portable, transportable launcher systems, which can be deployed locally, after determining the specific location of a pipeline leakage, the launcher systems comprising a launcher system and gel pig trains comprising at least one gel pig and at least one sealant composition.

The present invention provides a launcher system, adapted for deployment at a remote site, the launcher system including a launcher apparatus and a launcher apparatus carrier module for transporting the launcher apparatus to the remote site, the launcher system being configured to launch a pig train to seal a leakage in a pipeline network at the remote site. The remote site may be subterranean or submerged under water.

In some embodiments of the present invention, a system for launching improved apparatus are provided for launching pig trains for sealing pipelines at a location of a leakage. Some non-limiting examples of gel pig trains and gel pig compositions are described in WO2016/098093, WO2016/098094, WO2016/098095, WO2020202133A1 and WO2020202134A1, incorporated herein by reference in their entirety.

In some further embodiments of the present invention, improved apparatus is provided for sealing pipelines at a location of a leakage at a rural location.

In some further embodiments of the present invention, improved apparatus is provided for sealing pipelines at a location of a subterranean leakage.

In other embodiments of the present invention, apparatus is provided for sealing leaks in water transport pipelines.

There is thus provided according to an embodiment of the present invention, a method for curing at one leakage site in a pipeline, the method including
a. deploying a launcher system at a remote site; and
b. introducing a pig train into the pipeline from said launcher system, the pig train including;
   i) at least one gel pig; and
   ii) at least one sealant composition;
wherein the at least one gel pig and the at least one sealant composition form said pig train, thereby enabling the pig train to move along the pipeline to a region of the at least one leakage and to seal the at least one leakage.

According to some embodiments, the method further comprises following the sealing of leakage along the pipeline enabling the pig train to move to a downstream point for extraction of the remaining pig train.

According to some further embodiments, the method further comprises following the sealing of leakage along the pipeline enabling the pig train to stop and reverse its motion back to an upstream point for extraction of the remaining pig train.

There is thus provided according to an embodiment of the present invention, a launcher system, the launcher system comprising:
a) a launcher apparatus; and
b) a launcher apparatus carrier module, wherein the carrier module is configured to receive the launcher apparatus and adapted for human transport of the system to a remote site.

There is thus provided according to an embodiment of the present invention, a launcher apparatus for launching pig trains for sealing pipelines at a location of a leakage, the launcher apparatus comprising:
a) a conduit arrangement comprising:
   i. an inlet module for receiving a pig train;
   ii. an outlet module for releasing said pig train;
   iii. a pump;
   iv. a pressure gauge;
   v. connector conduits fluidly connected between said inlet module and said outlet module; and
   vi. valves for controlling at least one of a velocity and a head pressure of said pig train exiting said outlet module.

There is thus provided according to an embodiment of the present invention, a launcher apparatus for launching pig trains for sealing pipelines at a location of a leakage, the launcher apparatus comprising:
a) a conduit arrangement comprising:
   i. an inlet module for receiving a pig train;
   ii. an outlet module for releasing said pig train;
   iii. a pump;
   iv. a pressure gauge;
   v. three connector conduits fluidly connected generally perpendicularly between said inlet module and said outlet module, wherein said outlet module is disposed generally in parallel to said inlet module; and
   vi. valves for controlling at least one of a velocity and a head pressure of said pig train exiting said outlet module.

There is thus provided according to an embodiment of the present invention, a method for curing at one leakage site in a pipeline, the method including
a. locating a leakage at a remote site;
b. deploying a launcher system proximal to said remote site;
c. introducing a pig train into the pipeline from said launcher system, the pig train including;
   i) at least one gel pig; and
   ii) at least one sealant composition; wherein the at least one gel pig and the at least one sealant composition form said pig train; and
d. enabling the pig train to move along the pipeline to a region of the at least one leakage and to seal the at least one leakage.

There is thus provided according to an embodiment of the present invention, a method for curing at one leakage site in a pipeline, the method comprising:
a) Treated Pipe Pressurization—Pressurizing the to-be-treated-pipe-section from the Launcher to the designated pressure;
b) Leakage Measurement Test—Reading the digital flow meter and roto meter to determine the level of flow reflecting the level of aggregated leakage in the to-be-treated-pipe-section;
c) In-Situ Materials Preparation—Mixing, blending, pouring and otherwise preparing prepackaged components that form the basis the materials comprising the pig train;
d) Loading the Launcher-Tightly loading the launching tube with the materials in the proper order to form the pig train;
e) Setting Drive Flow-Opening a discharge valve downstream of the treated-pipe-section to determine the level of flow of water and therefore setting the speed of the pig train;
f) Launching—Creating a flow path to include the pig train therefore inducing its launch from the launching tube into the treated-pipe-section;
g) Driving Pig Train—Monitoring the drive flow and when it drops due to a leak seal increasing it back to the drive flow at launch;
h) Retrieving Pig Train—At the end of its path allowing the pig train to be extracted downstream from the treated-pipe-section; and
i) Leakage Measurement Test—Reading the digital flow meter and roto meter to determine the level of flow reflecting the residual level of aggregated leakage in the treated-pipe-section.

There is thus provided according to an embodiment of the present invention, a launcher system apparatus, adapted for local deployment and use to seal a local leakage in a pipeline network, the launcher system comprising:
a) at least one input filter;
b) at least one check valve;
c) a pipe manifold configured to feed three flow paths;
d) an outlet to the treated pipe section into which a pig train is launched;
e) an outlet to an upstream point for extraction of the remaining pig train;
f) an outlet for back pressurizing downstream of the stopped pig train back towards the launcher;
g) a launching conduit configured to house a pig train prior to launching; at least one flow meter; and
h) pressure gauges that measure the pressures at the input and output of the launcher.

There is thus provided according to an embodiment of the present invention, a launcher system for launching gel pig trains for sealing pipelines at a location of a leakage, the launcher system comprising:
a) a launcher apparatus; and
b) a launcher apparatus carrier module, wherein the carrier module is configured to receive the launcher apparatus and adapted for human transport of the system to a remote site.

There is thus provided according to an embodiment of the present invention, a launcher apparatus for launching pig trains for sealing pipelines at a location of a leakage, the launcher apparatus comprising:
a conduit arrangement comprising:
   a) an inlet module for receiving a pig train;
   b) an outlet module for releasing said pig train;
   c) a pump;
   d) a pressure gauge;
   e) connector conduits fluidly connected between said inlet module and said outlet module; and
   f) valves for controlling at least one of a velocity and a head pressure of said pig train exiting said outlet module.

There is thus provided according to an embodiment of the present invention, a launcher apparatus for launching pig trains for sealing pipelines at a location of a leakage, the launcher apparatus comprising:
a conduit arrangement comprising:
   a) an inlet module for receiving a pig train;
   b) an outlet module for releasing said pig train;
   c) a pump;
   d) a pressure gauge;
   e) three connector conduits fluidly connected generally perpendicularly between said inlet module and said outlet module, wherein said outlet module is disposed generally in parallel to said inlet module; and
   f) valves for controlling at least one of a velocity and a head pressure of said pig train exiting said outlet module.

Additionally, according to an embodiment of the present invention, the at least one gel pig includes one gel pig and the at least one sealant composition includes one sealant composition.

Moreover, according to an embodiment of the present invention, the at least one gel pig includes two gel pigs and the at least one sealant composition includes one sealant composition.

Further, according to an embodiment of the present invention, the at least one gel pig includes three gel pigs and the at least one sealant composition includes two sealant compositions.

Still further, according to an embodiment of the present invention, the pig train is a gel pig train.

Yet further, according to an embodiment of the present invention, the pig train moves along the pipeline at a speed of 0.01 to 10 m/s.

Furthermore, according to an embodiment of the present invention, the at least one gel pig includes one rear pig.

Additionally, according to an embodiment of the present invention, at least one of the two pigs has an average diameter of at least 5% less than an internal diameter of the pipeline.

Moreover, according to an embodiment of the present invention, at least one of the two pigs has an average diameter of at least 10% less than an internal diameter of the pipeline.

Importantly, according to an embodiment of the present invention, the at least one gel pig includes;
a. a cellulosic polysaccharide;
b. a surfactant; and
c. water.

Additionally, according to an embodiment of the present invention, the at least one gel pig further includes;
d. a filler; and
e. a metallic hydroxide.

According to another embodiment of the present invention, the at least one gel pig further includes an oil.

Moreover, according to an embodiment of the present invention, the at least one gel pig includes a rear pig and a front pig of different compositions.

Furthermore, according to an embodiment of the present invention, wherein the pig train conforms to an inner profile of the pipeline.

Additionally, according to an embodiment of the present invention, the inner profile of the pipeline is reduced in diameter in at least one section by at least 20%.

Further, according to an embodiment of the present invention, the inner profile of the pipeline is reduced in diameter in at least one section by at least 50%.

Yet further, according to an embodiment of the present invention, the inner profile of the pipeline is reduced in diameter in at least one section by at least 75%.

Additionally, according to an embodiment of the present invention, the inner profile of the pipeline is further increased in the diameter in at least one section by at least 20%.

Moreover, according to an embodiment of the present invention, the inner profile of the pipeline is increased in the diameter in at least one section by at least 50%.

Additionally, according to an embodiment of the present invention, the inner profile of the pipeline is increased in the diameter in at least one section by at least 75%.

Furthermore, according to an embodiment of the present invention, the method further includes propelling a pressurized fluid from a first end thereof along the pipeline.

Additionally, according to an embodiment of the present invention, the pressurized fluid includes a liquid.

Moreover, according to an embodiment of the present invention, the pressurized fluid includes a gas.

Further, according to an embodiment of the present invention, the pressurized fluid includes a tri-phase fluid.

Yet further, according to an embodiment of the present invention, the pressurized fluid is at a pressure of 1-150 bar.

Additionally, according to an embodiment of the present invention, the pig train prevents a bypass of a propelling product by of more than 30%.

Moreover, according to an embodiment of the present invention, the method further includes extracting the pig train from the pipeline via a conduit of less than two inch diameter at a pressure of less than 3 bar.

Furthermore, according to an embodiment of the present invention, the method further includes introducing or launching the pig train into the pipeline via a conduit of less than two inch diameter at a pressure of less than 5 bars.

Additionally, according to an embodiment of the present invention, the method further includes counter-pressurizing the pig train from a second end of the pipeline with a counter pressurized fluid.

Further, according to an embodiment of the present invention, the counter pressurized fluid is for controlling velocity of movement of the pig train along the pipeline.

Yet further, according to an embodiment of the present invention, the pig train is launched from a pipe of a diameter of less than 75% of the pipeline.

Additionally, according to an embodiment of the present invention, the pig train is launched from a pipe of a diameter of less than 50% of the pipeline.

In some cases, according to an embodiment of the present invention the pig train is launched from a pipe of a diameter of less than 75% of the pipeline.

Additionally, according to an embodiment of the present invention, the pig train is launched from a pipe at an angle of greater than 30° to the pipeline.

Furthermore, according to an embodiment of the present invention, the pig train is launched from a pipe at an angle of greater than 60° to the pipeline.

In some cases, according to an embodiment of the present invention, the pig train is launched from a pipe at an angle of greater than 80° to the pipeline.

Additionally, according to an embodiment of the present invention, the pig train is launched from a pipe at a pressure in the range of 2-15 bar.

Further, according to an embodiment of the present invention, the pig train is launched from a pipe at a pressure in the range of 2-5 bar.

Importantly, according to an embodiment of the present invention, the pig train travels through an obstruction in the pipeline and is operative thereafter.

Additionally, according to an embodiment of the present invention, the obstruction is selected from the group consisting of a butterfly valve, a wedge, a nail, a screw, an obstructing element, an in-pipe meter, a service pipe ferrule, an incrustation and a tuberculation, a baffle, a broomstick seal and combinations thereof.

The present invention provides systems and methods for curing a leakage in a pipeline, the system including at least one gel pig and at least one sealant composition; wherein the at least one gel pig and the at least one sealant composition form a pig train, adapted to move along the pipeline to a region of the leakage and to seal the leakage.

The present invention will be more fully understood from the following detailed description of the preferred embodiments thereof, taken together with the drawings.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A is a simplified schematic diagram of a launcher system for local deployment for sealing a pipeline, in accordance with an embodiment of the present invention;

FIG. 1B is another simplified schematic diagram of a launcher system for local deployment for sealing a pipeline, in accordance with an embodiment of the present invention;

FIG. 2A is a simplified pictorial illustration of a launcher apparatus for local deployment for sealing a pipeline, in accordance with an embodiment of the present invention;

FIG. 2B is a simplified pictorial illustration of rear view of a launcher system carrier module for local deployment for sealing a pipeline, in accordance with an embodiment of the present invention;

FIG. 2C is a simplified pictorial illustration of a launcher apparatus for local deployment for sealing a pipeline, in accordance with an embodiment of the present invention;

FIG. 2D is another simplified pictorial illustration of a launcher apparatus for local deployment for sealing a pipeline, in accordance with an embodiment of the present invention;

FIG. 3 is a simplified flow chart of a method for setting up a launcher system of FIG. 2A, in accordance with an embodiment of the present invention;

FIG. 4 is a simplified flow chart of a method for launching a pig train into a pipeline network deploying the apparatus of FIG. 2A, in accordance with an embodiment of the present invention;

FIG. 5 is a simplified flow chart of a method of operating a launcher apparatus in conjunction with the appropriate steps detailed in the flow charts of FIG. 3 and FIG. 4 in accordance with an embodiment of the present invention;

FIG. 6 is a simplified schematic diagram of a system for operating a launcher apparatus in a pipe section, in accordance with an embodiment of the present invention;

FIG. 7 is a simplified schematic diagram of another system for operating a launcher apparatus in a pipe section, in accordance with an embodiment of the present invention. In all the figures similar reference numerals identify similar parts; and

FIG. 8 is a simplified high level flow chart of a method for setting up a launcher system of FIG. 1B, in accordance with an embodiment of the present invention.

### DETAILED DESCRIPTION OF THE EMBODIMENTS

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

The present disclosure describes launcher systems and methods, the systems adapted for local deployment and use to launch a gel pig train, configured to be passed in a pipeline or pipeline network to a vicinity of a leak (typically subterranean) and to seal a local leakage in the pipeline network. The pipeline network may be configured to hold any fluid, such as, but not limited to water, drinking water, gas, fuel, gasoline, natural gas and combinations thereof.

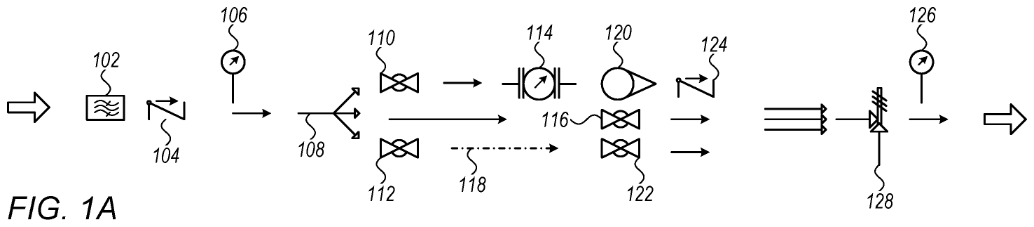

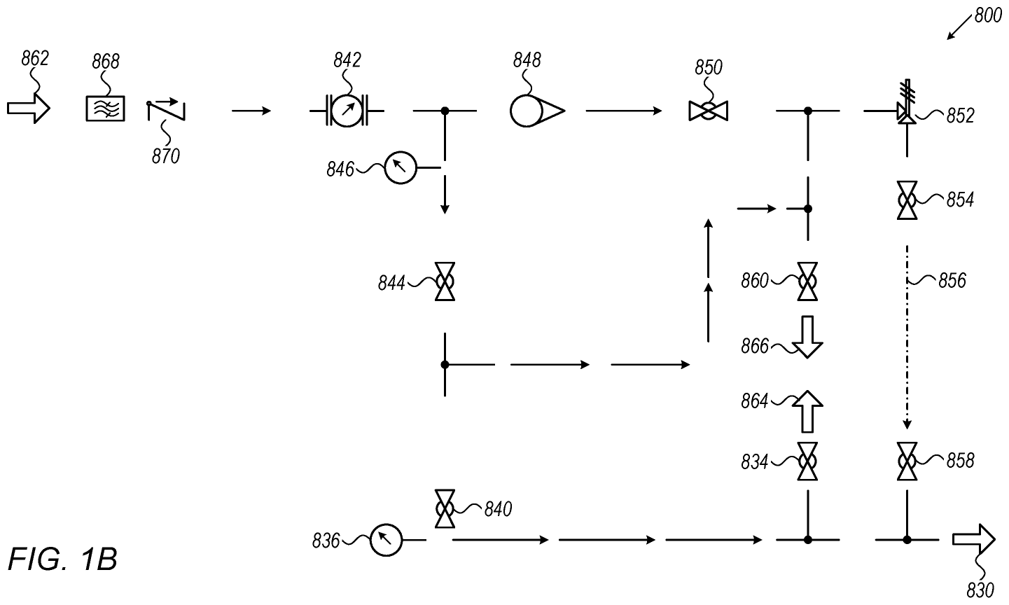

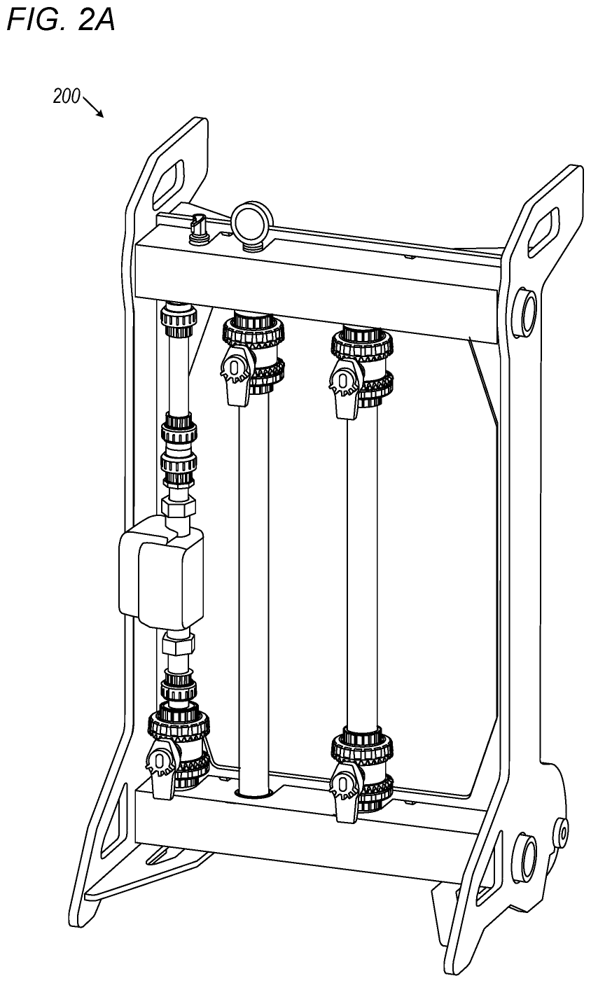

Reference is now made to FIG. 1A, which is a simplified schematic diagram of a launcher system 100 for local deployment of a gel pig train for sealing a pipeline, in accordance with an embodiment of the present invention.

With reference to FIG. 1A, the separate components of launcher system 100 for local deployment for sealing a pipeline are as follows:
a) Input filter (102) filters the inlet pressurized water from any incoming debris in the network.
b) Check valve (102) protects the pressurized network from the backflow of and pig train materials.
c) Pressure meters (106) and (126) measure the inlet and outlet pressures respectively.
d) Pipe manifold (108) feeds three respective flow paths that have provide the functionality of (i) a flow path for pipe pressurization and high flow flushing (ii) a flow path for launching the pig train and (iii) a flow path for measuring the levels of flow.
e) Block valves (110, 112, 116 and 122) that turn on and off the flow of water and pig train materials as needed.
f) Launching tube (118) housed the pig train prior to launching.
g) Digital flow meter (114) and roto meter (120) that measure the levels of water flow prior to, during and post intervention.
h) Check valve (124) protects the roto meter (120) from the backflow of pig train materials.
i) An air relief valve (128) that allows extraction of air bubbles in the system to be released prior to the intervention.

Launcher system 100 is constructed and configured to enable some or all of the following functionalities:
a) Connection to an isolated treated pipe section at an insertion point for the purpose of launching a pig train into the pipe section via a predetermined flow path towards a downstream extraction point;
b) Connection to a pressurized water source to enable propelling the pig train into the isolated treated pipe section;
c) Sequentially providing and assembling components of a pig train to be loaded into a launching tube prior to launching;
d) Pressurizing the leaky treated pipe section to the desired pressure by allowing a flow path via block valve (116);
e) Performing a Leakage Measurement Test (LMT) of the level of aggregate leakage in the leaky treated pipe section applying digital flow meter (114) and roto meter (120) while maintaining the desired water pressure through valve (110). The LMT procedure may be in accordance with that described in international PCT patent application PCT/IL2020/050988 to Peter Paz, PCT publication number WO2021053662A1, “Quantitative method of measuring leakage volume”, incorporated herein in its entirety by reference.
f) Setting the level of a drive flow applying a discharge valve at the downstream extraction point that determines the speed of launch of the pig train into the leaky treated pipe section;
g) Extraction of air bubbles from the launcher system and/or pig train vis air relief valve (128) prior to launching thereof;
h) Launching a pig train into a leaky pipe section while maintaining the desired water pressure and desired drive flow through valve (112) and (122);
i) Continuous monitoring of the drive flow through digital flow meter (114) and roto meter (120) to determine the drop in drive flow during the treatment process which provides the quantitative amount of leakage reduction by the process; and
j) Post-treatment allowing a high flow of water to flush out any remaining materials in the treated pipe section prior to reinstatement of service through valve (116) by discharging the flushing via a discharge valve at the downstream extraction point.

The launcher apparatus can serve a leak repair intervention for pipe diameters up to and including 63 mm of any type of materials such as polyethylene, PVC, steel, cast iron and asbestos cement. Lengths of treated pipe sections can range from 1 meter to 100 meters, have up to 10 leaks and more each leak may be up to a limit of 10,000 liters-per-hour. Operational pressures may be up to 20 bars or more. The speed of the intervention may range from 5 centimeters-per-second to 100 centimeters-per-second and post intervention flushing rates may range from 5 litres-per-minute to 800 liters per minute depending on pipe diameter among other factors.

Reference is now made to FIG. 1B, which is a simplified schematic diagram of another launcher system 800 for local deployment for sealing a pipeline, in accordance with an embodiment of the present invention.

With further reference to FIG. 1B, the separate components of launcher system 800 for local deployment for sealing a pipeline are as follows:
a) Input filter (868) filters the inlet pressurized water from any incoming debris in the network.
b) Check valve (870) protects the pressurized network from the backflow of and pig train materials.
c) Pressure meters (846) and (836) measure the inlet and outlet pressures respectively.
d) Block and throttle valves (844, 840, 850,854, 858, 834 and 860) that turn on and off the flow of water and/or pig train materials as needed.
e) Launching tube (856) housed the pig train prior to launching.
f) Digital flow meter (842) and roto meter (848) that measure the levels of water flow prior to, during and post intervention.
g) Check valve (870) protects the roto meter (848) from the backflow of pig train materials.
h) An air relief valve (852S) that allows extraction of air bubbles in the system to be released prior to the intervention.

The launcher system is constructed and configured to enable some or all of the following functionalities:
a) Connection to an isolated treated pipe section at an insertion point for the purpose of launching a pig train into the pipe section via a predetermined flow path towards a downstream extraction point;
b) Connection to a pressurized water source to enable propelling the pig train into the isolated treated pipe section;
c) Sequentially providing and assembling components of a pig train to be loaded into a launching tube prior to launching;
d) Pressurizing the leaky treated pipe section to the desired pressure by allowing a flow path via throttle valve (844) with minimum pressure transients in the system;
e) Performing a Leakage Measurement Test (LMT) of the level of aggregate leakage in the leaky treated pipe section applying digital flow meter (842) and roto meter (848) while maintaining the desired water pressure through valves (844) and (840);
f) Setting the level of a drive flow applying a discharge valve at the downstream extraction point that determines the speed of launch of the pig train into the leaky treated pipe section;
g) Extraction of air bubbles from the launcher system and/or pig train vis air relief valve (852) prior to launching thereof;
h) Launching a pig train into a leaky pipe section while maintaining the desired water pressure and desired drive flow through valve (854) and (858);
i) Continuous monitoring of the drive flow through digital flow meter (842) and roto meter (848) to determine the drop in drive flow during the treatment process which provides the quantitative amount of leakage reduction by the process;
j) If downstream network extraction of the pig train is not possible enabling a complete stoppage of drive flow through the sealing of the last leak during the treatment process in which case the pig train comes to a complete stop.
k) Enabling a reverse of its motion by back pressurizing via valves (844) and (860) and a specially prepared pipe inlet downstream of the stopped pig train back towards launcher system 800 in preparation for extraction.
l) Enabling the shunting of the reversed pig train via outlet (830) block valve (834) and outlet (864) towards a retrieving unit for extraction.
m) Post-treatment allowing a high flow of water to flush out any remaining materials in the treated pipe section prior to reinstatement of service through valves (844) and (840) by discharging the flushing via a discharge valve at the downstream extraction point.

The launcher apparatus can serve a leak repair intervention for pipe diameters up to and including 63 mm of any type of materials such as but not limited to polyethylene, PVC, steel, cast iron and asbestos cement. Lengths of treated pipe sections can range from 1 meter to 100 meters, have up to 10 leaks and more each leak may be up to a limit of 10,000 liters-per-hour. Operational pressures may be up to 20 bars or more. The speed of the intervention may range from 5 centimeters-per-second to 100 centimeters-per-second and post intervention flushing rates may range from 5 litres-per-minute to 800 liters per minute depending on pipe diameter among other factors. Furthermore, the launcher apparatus supports the reverse motion of the pig train and shunts it towards a retriever unit for extraction if downstream network extraction is not possible.

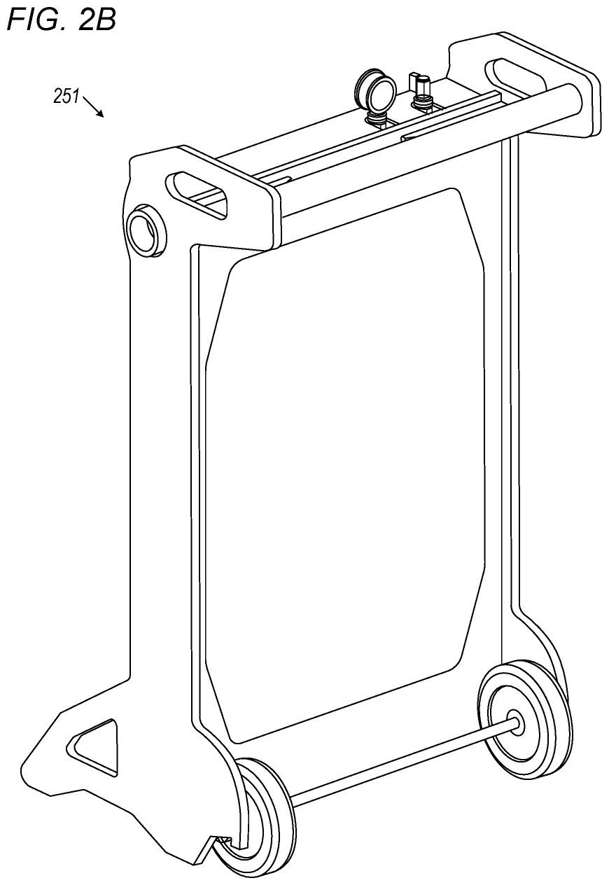

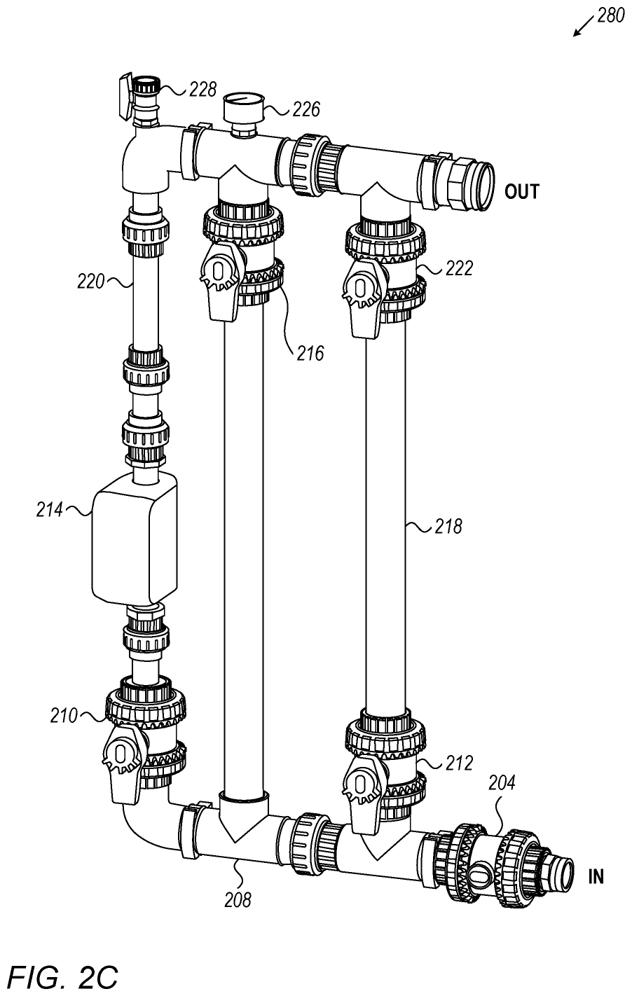

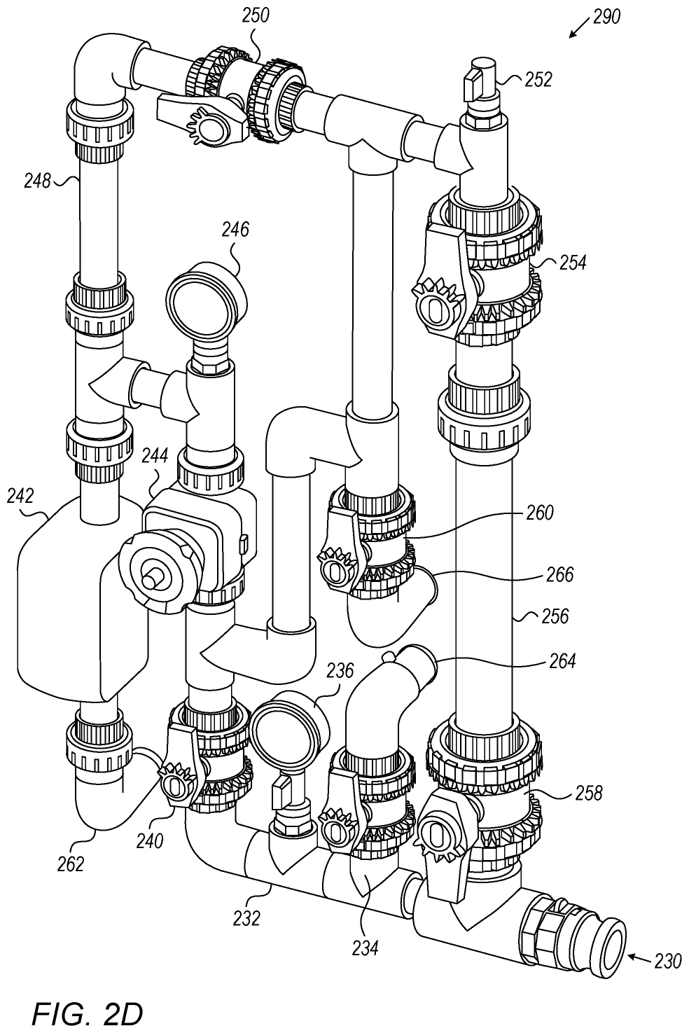

FIG. 2A is a simplified pictorial illustration of a front view of a launcher apparatus 200 for local deployment for sealing a pipeline, in accordance with an embodiment of the present invention. The launcher apparatus comprises a carrier module 202 for housing the launcher system 100 (FIG. 1).

FIG. 2B is a simplified pictorial illustration of rear view 251 of a launcher system carrier module 202 of FIG. 2A for local deployment of a pig train, also termed “systems” (such as, but not limited to systems 100 and 500 of WO2016/098093, systems 100, 120 or 140 of WO2020202133A1) for sealing a pipeline, in accordance with an embodiment of the present invention.

FIG. 2C and FIG. 2D are simplified pictorial illustrations of some of the components of a launcher apparatus 280 and 290, respectively (equivalent to system 100 (FIG. 1A)) for local deployment for sealing a pipeline, in accordance with an embodiment of the present invention.

With further reference to FIG. 2C, the separate components of launcher system 280 for local deployment for sealing a pipeline are as follows:
a) Check valve (204) protects the pressurized network from the backflow of and pig train materials.
b) Pressure meter (226) measures the outlet pressures respectively.
c) Block and throttle valves (210, 212, 216, and 222) that turn on and off the flow of water and/or pig train materials as needed.
d) Launching tube (218) houses the pig train prior to launching.
e) Digital flow meter (214) and roto meter (240) measures the levels of water flow prior to, during and post intervention.
f) Check valve (204) protects the roto meter (220) from the backflow of pig train materials.
g) An air relief valve (228) that allows extraction of air bubbles in the system to be released prior to the intervention.

With further reference to FIG. 2D, the separate components of launcher system 290 for local deployment for sealing a pipeline are as follows:
a) An inlet 262 from a water source;
b) A check valve (204) protects the pressurized network from the backflow of and pig train materials.
c) A pressure meter (246) measures the outlet pressures respectively.
d) Block and throttle valves (240, 244, 250, 254 and 258) that turn on and off the flow of water and/or pig train materials as needed.
e) A launching tube (256) houses the pig train prior to launching to an outlet (230).
f) A digital flow meter (242) and a pressure meter (246) measures the levels of water flow and pressure, respectively, prior to, during and post intervention.
g) A throttle valve (244) protects a roto meter (248) from the backflow of pig train materials.
h) A pipe manifold 208, which fluidly connects the inlet to the outlet.
i) A manifold 232 that fluid connects the inlet to the outlet;

An air relief valve (252) that allows extraction of air bubbles in the system to be released prior to the intervention.

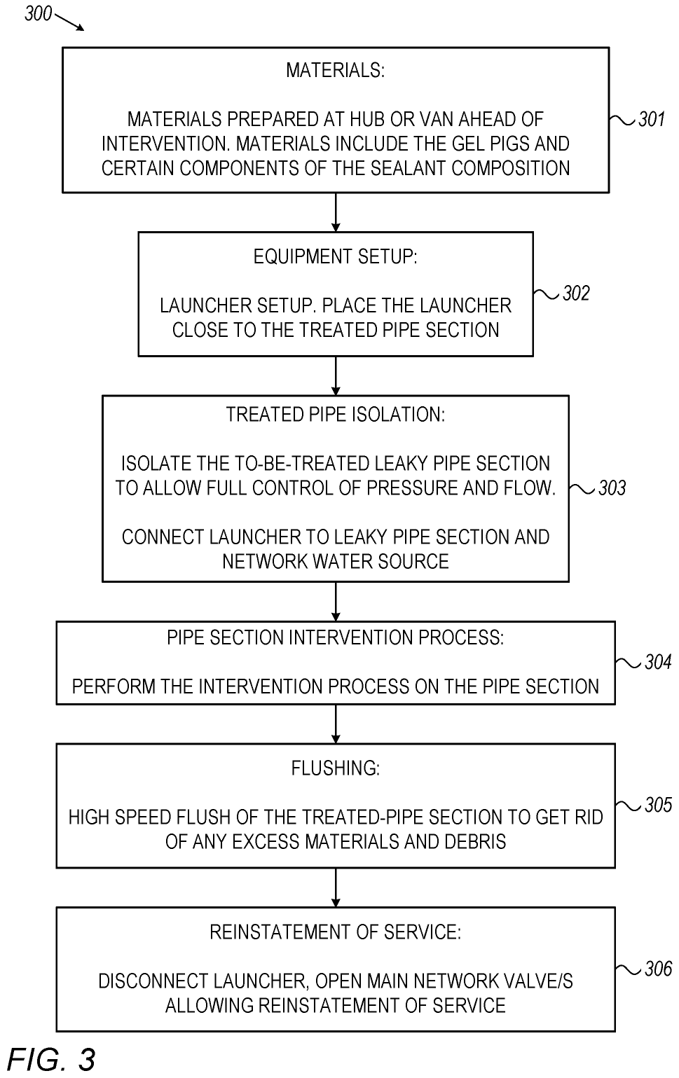

FIG. 3 is a simplified flow chart 300 of a method for setting up a launcher system of FIG. 2, in accordance with an embodiment of the present invention.

High Level Process of Intervention method 300 steps.
Step 301 Materials preparation—Materials prep at hub or van ahead of intervention.
Step 302 Equipment Setup—Launcher setup.
Step 303 Treated Pipe Isolation—Isolation of the to-be-treated leaky pipe section. Connecting launcher to leaky pipe section and network water source.
Step 304 Pipe Section Treatment—Performing a pipe section treatment process.
Step 305 Flushing—High speed flushing of the to-be-treated-pipe section; and
Step 306 Reinstatement of Service—Disconnection of Launcher, opening up of mains network valve/s allowing reinstatement of service.

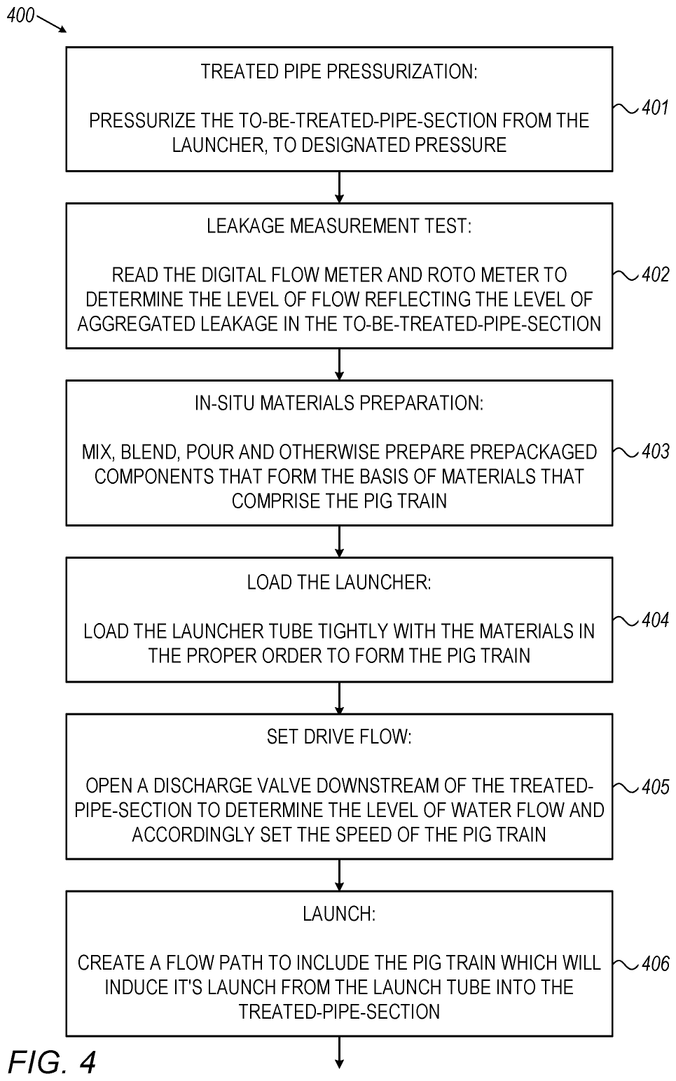

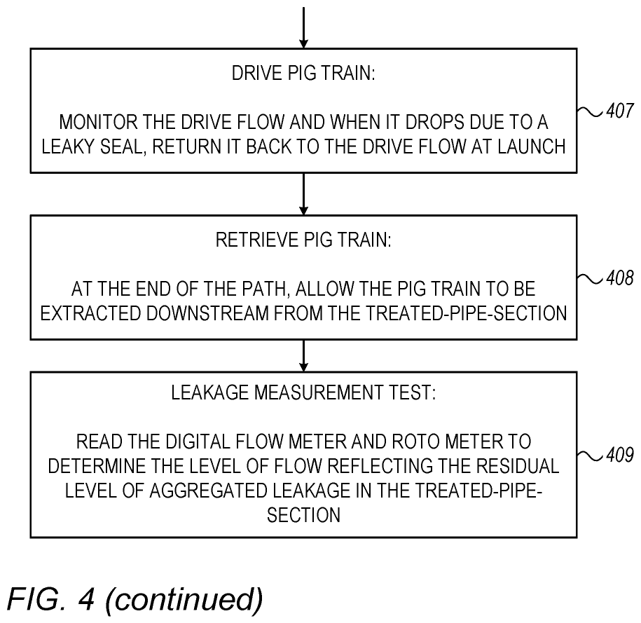

FIG. 4 is a simplified flow chart 400 of a method for launching a pig train into a pipeline network deploying the apparatus of FIG. 2A, in accordance with an embodiment of the present invention. This flow chart provides more detail on the steps relating to Step 304 of FIG. 3.
Step 401 Treated Pipe Pressurization—Pressurizing the to-be-treated-pipe-section from the Launcher to the designated pressure.
Step 402 Leakage Measurement Test—Reading the digital flow meter and roto meter to determine the level of flow reflecting the level of aggregated leakage in the to-be-treated-pipe-section.
Step 403 In-Situ Materials Preparation—Mixing, blending, pouring and otherwise preparing prepackaged components that form the basis the materials comprising the pig train.
Step 404 Loading the Launcher-Tightly loading the launching tube with the materials in the proper order to form the pig train.
Step 405 Setting Drive Flow-Opening a discharge valve downstream of the treated-pipe-section to determine the level of flow of water and therefore setting the speed of the pig train.
Step 406 Launching—Creating a flow path to include the pig train therefore inducing its launch from the launching tube into the treated-pipe-section.
Step 407 Driving Pig Train—Monitoring the drive flow and when it drops due to a leak seal increasing it back to the drive flow at launch.
Step 408 Retrieving Pig Train—At the end of its path allowing the pig train to be extracted downstream from the treated-pipe-section; and
Step 409 Leakage Measurement Test—Reading the digital flow meter and roto meter to determine the level of flow reflecting the residual level of aggregated leakage in the treated-pipe-section.

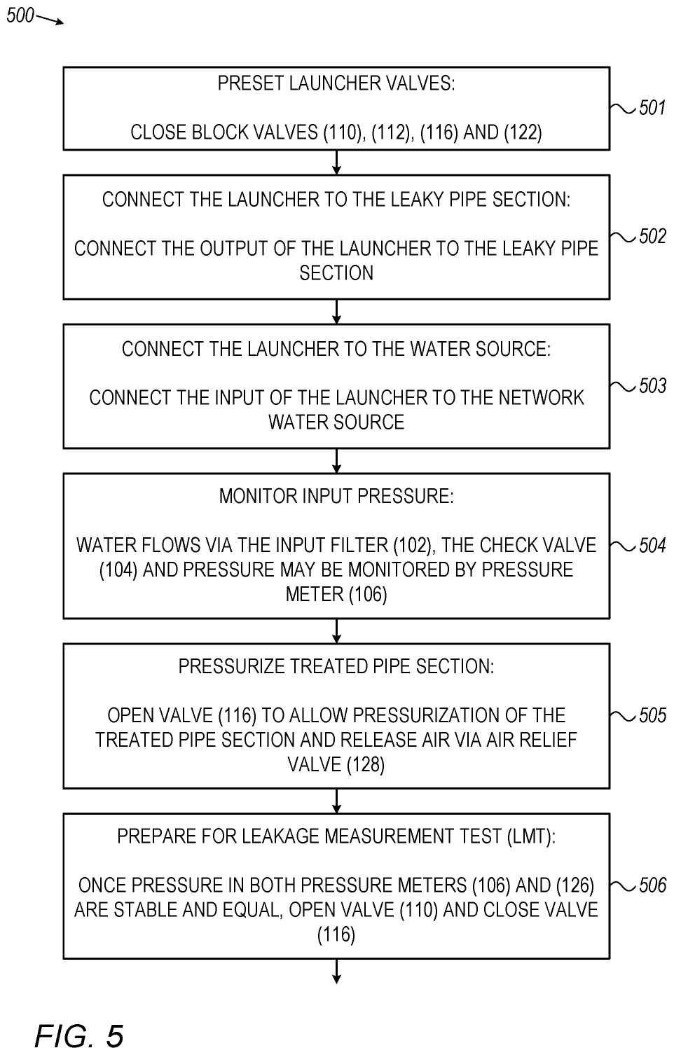

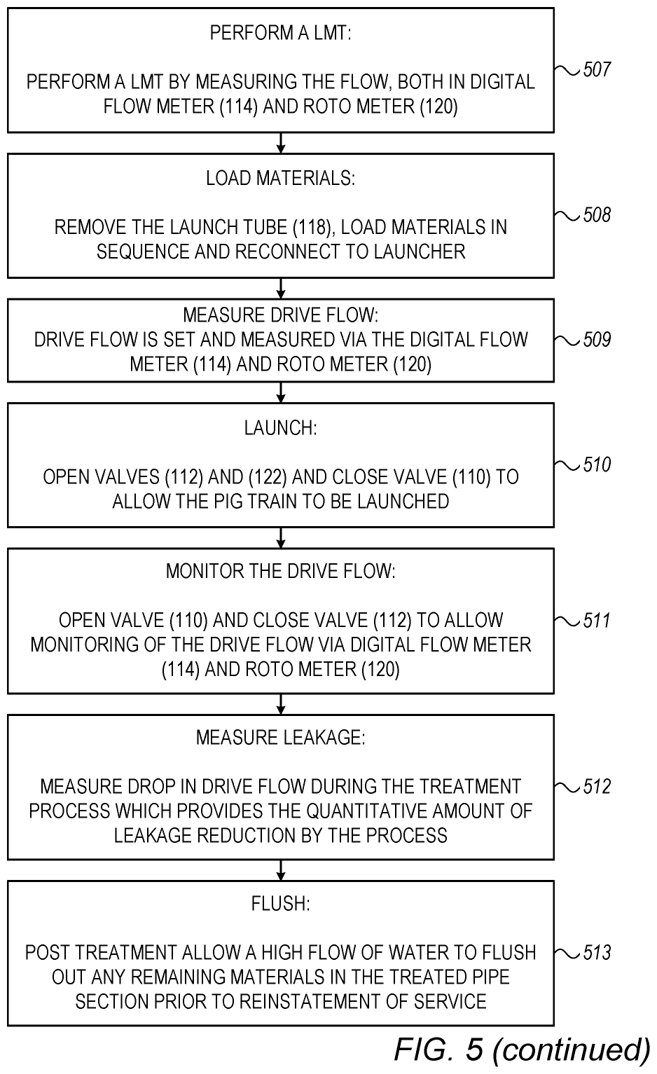

FIG. 5 is a simplified flow chart 500 of a method of operating the Launcher apparatus in conjunction with the appropriate steps detailed in the flow charts of FIG. 3 and FIG. 4.
Step 501 Preset Launcher valves—Close block valves (110), (112), (116) and (122).
Step 502 Connect the Launcher to the leaky pipe section—Connect the output of the Launcher to the leaky pipe section.
Step 503 Connect the Launcher to the water source—Connect the input of the Launcher to the network water source.
Step 504 Monitor input pressure—Water will flow via the input filter (102), the check valve (104) and pressure may be monitored by a pressure meter (106).
Step 505 Pressurize treated pipe section—Open valve (116) to allow pressurization of the treated pipe section and air release via air relief valve (128).
Step 506 Prepare for Leakage Measurement Test (LMT)—Once pressure in both pressure meters (106 and (126) is stable and equal, open valve (110) and close valve (116).
Step 507 Perform an LMT—Perform an LMT by measuring the flow both in digital flow meter (114) and roto meter (120).
Step 508 Loading pig train materials—Remove the launching tube (118) also see (218) in apparatus 280 and (256) in apparatus 290, load materials in sequence and reconnect to Launcher. These materials typically comprise one or more gel pigs and one or more sealant compositions. In a non-limiting example, the first to be loaded is a rear gel pig or a combination of rear gel pigs extracted from cylindrical canisters. Next to loaded is a sealant composition pre-prepared or prepared in situ. Last to be loaded is a lead (front) gel pig or a combination of lead gel pigs extracted from cylindrical canisters. Materials are loaded snugly so that no air space is left between them. The gel pigs used in the present invention may be identical or similar to those disclosed in U.S. Pat. No. 10,302,235 and or U.S. Pat. No. 10,302,236, incorporated herein by reference in their entirety.
Step 509 Measuring drive flow—Drive flow is set and measured via the digital flow meter (114) and roto meter (120).
Step 510 Pig train Launching—Open valves (112) and (122) and close valve (110) to allow the pig train to be launched.
Step 511 Monitoring the drive flow—Open valve (110) and close valve (112) to allow monitoring of the drive flow via digital flow meter (114) and roto meter (120).
Step 512 Measuring leakage—Measure the drop in drive flow during the treatment process which provides the quantitative amount of leakage reduction by the process. As an example, if the drive flow was originally 600 liters-per-hour in a 25 mm diameter treated pipe section and during the treatment process the drive flow reduced first by 200 liters-per-hour then by an additional 300 liters-per-hour it can be deduced that the quantitative amount of leakage reduction by the process in this pipe section was 500 liters-per-hour in total.
Step 513 Flushing—post treatment allows a high level of flow of water (typically ranging from 600 liters-per-hour 6,000 liters-per-hour) to flush out any remaining materials in the treated pipe section prior to reinstatement of service. A high level of flow could be for example a level of flow of 3,000 liters-per-hour for a 25 mm diameter pipe or a level of flow of 2,000 liters-per-hour for a 16 mm diameter pipe.

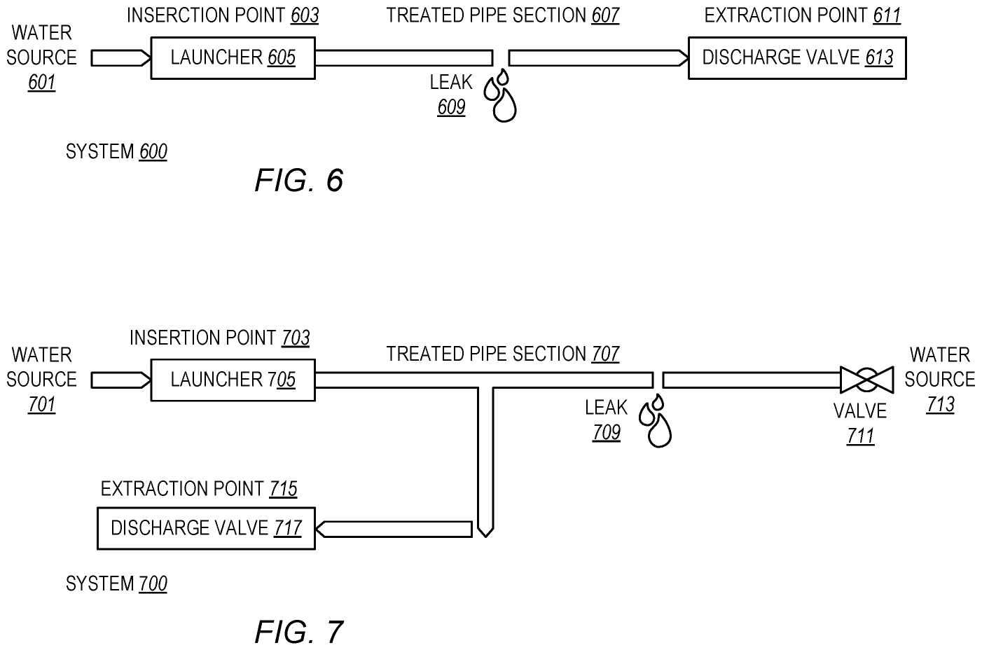

FIG. 6 is a simplified schematic diagram of a system 600 for operating a launcher apparatus in a pipe section which has an available insertion point 603 for the pig train to be launched into applying pressure from a water source 601. A pig train (not shown) is driven within the treated pipe section 607 in the direction of Extraction point 609 with a drive flow that is made up of the flow of Leak 609 and a discharge flow induced by opening a discharge valve 609. Along the way, leak 609 is sealed and upon arrival the pig train is extracted via an extraction point 611.

FIG. 7 is a simplified schematic diagram of a system 700 for operating a launcher apparatus in a pipe section 707 which has an available insertion point 703 for the pig train (not shown) to be launched into applying pressure from a water source 701. However, there is no available extraction point downstream. There is a network valve 711 which, in the first instance is closed off. In this case the drive flow is made up of the flow of leak 709 alone and upon arrival the pig train seals leak 709 thus bringing the pig train to a halt. In the second instance, the water source 701 is closed off, valve 711 is opened and a second water source 713 is made available to the treated pipe section 707. A discharge valve 711 is now opened and the pig train is driven in the opposite direction and shunted in the direction of Extraction point 715 with a drive flow which is made up of the discharge flow alone induced by opening discharge valve 717. Upon arrival, the pig train is extracted via extraction point 715.

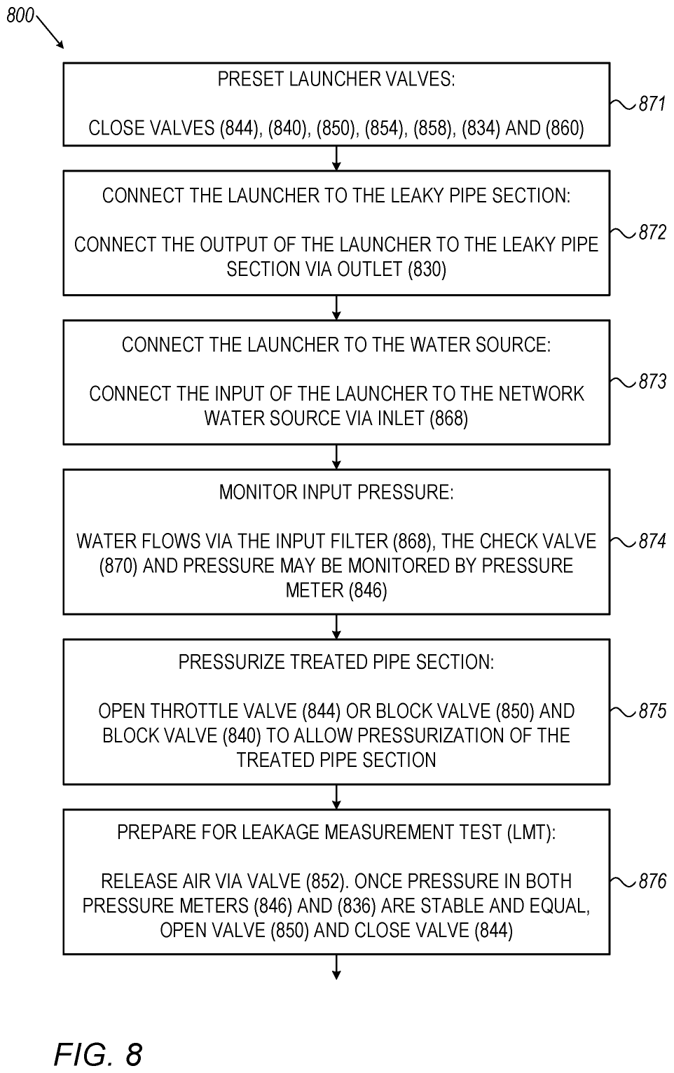

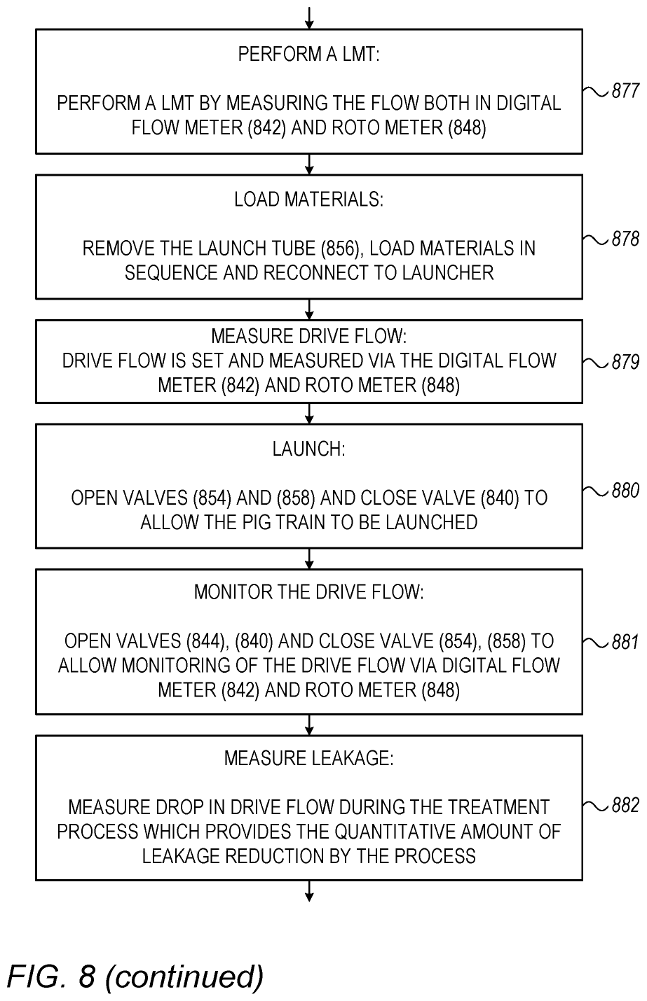

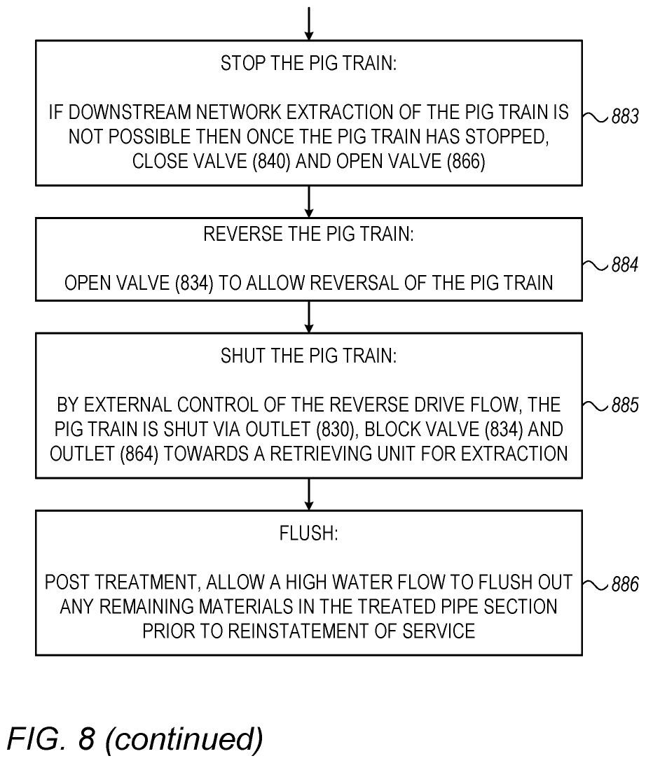

FIG. 8 is a simplified flow chart 890 of a method for setting up a launcher system 800 of FIG. 1B, in accordance with an embodiment of the present invention; Some of the steps are further detailed in other figures.
Step 871 Preset Launcher valves—Close block valves (844), (850), (854), (858), (834) and (860).
Step 872 Connect the Launcher to the leaky pipe section via outlet (830.
Step 873 Connect the Launcher to the water source—Connect the input of the Launcher to the network water source via inlet 868.
Step 874 Monitor input pressure—Water will flow via the input filter (868), the check valve (870) and pressure may be monitored by a pressure meter (846).
Step 875 Pressurize treated pipe section—Open throttle valve (844) or block valve (840) to allow pressurization of the treated pipe section.
Step 876 Prepare for Leakage Measurement Test (LMT)—Once pressure in both pressure meters (846) and (836) is stable and equal, open valve (850) and close valve (844).
Step 877 Perform an LMT—Perform an LMT by measuring the flow both in digital flow meter (842) and roto meter (848).
Step 878 Loading pig train materials—Remove the launching tube (856) (also see (218) in apparatus 280 and (256) in apparatus 290) load materials in sequence and reconnect to Launcher. These materials typically comprise one or more gel pigs and one or more sealant compositions. In a non-limiting example, the first to be loaded is a rear gel pig or a combination of rear gel pigs extracted from cylindrical canisters. Next to loaded is a sealant composition pre-prepared or prepared in situ. Last to be loaded is a lead (front) gel pig or a combination of lead gel pigs extracted from cylindrical canisters. Materials are loaded snugly so that no air space is left between them.
Step 879 Measuring drive flow—Drive flow is set and measured via the digital flow meter (842) and roto meter (848).
Step 880 Pig train Launching—Open valves (854) and (858) and close valve (840) to allow the pig train to be launched.
Step 881 Monitoring the drive flow—Open valves (844) and (840) and close valves (854) and (858) to allow monitoring of the drive flow via digital flow meter (842) and roto meter (848).
Step 882 Measuring leakage—Measure the drop in drive flow during the treatment process which provides the quantitative amount of leakage reduction by the process. As an example, if the drive flow was originally 600 liters-per-hour in a 25 mm diameter treated pipe section and during the treatment process the drive flow reduced first by 200 liters-per-hour then by an additional 300 liters-per-hour it can be deduced that the quantitative amount of leakage reduction by the process in this pipe section was 500 liters-per-hour in total.
Step 883 Stopping the pig train-if downstream network extraction of the pig train is not possible, then once the pig train has stopped, close valve (840) and open valve (866)
Step 884 Reversing the pig train—Open valve (834) to allow reversing of the pig train.
Step 885 Shunting the pig train—by externally controlling the reverse drive flow, the pig train is shunted via outlet (830) block valve (834) and outlet (864) towards a retrieving unit for extraction.
Step 886 Flushing—post treatment allows a high level of flow of water (typically ranging from 600 liters-per-hour 6,000 liters-per-hour) to flush out any remaining materials in the treated pipe section prior to reinstatement of service. A high level of flow could be for example a level of flow of 3,000 liters-per-hour for a 25 mm diameter pipe or a level of flow of 2,000 liters-per-hour for a 16 mm diameter pipe.

Some non-limiting examples of the gel pig compositions appear in the examples hereinbelow. Some non-limiting examples of the sealant compositions are disclosed in Israel Patent No. 180474.

A non-limiting example of the composition is:
a) At least one organic or inorganic filler selected from carbon ash, aluminum hydroxide, calcium carbonate, calcium hydroxide, magnesium hydroxide, magnesium carbonate, titanium hydroxide, silica, similar fillers and combinations thereof in a weight ratio of 0.01-3% wt/wt.
b) At least one gelling agent selected from carrageenan, agar agar, hydroxymethylcelluose, hydroxyethyl cellulose, hydroxypropyl cellulose and combinations thereof in a weight ratio of 0 to 20% wt/wt.
c) A coloring agent selected from a water soluble dye, a water insoluble dye, a paint, an oxide, a metal oxide and combinations thereof in a weight ratio of 0 to 1% wt/wt.
d) At least one surfactant selected from an ionic surfactant, an anionic surfactant, a detergent, an edible oil, an inedible oil and combinations thereof in a weight ratio of 0.01 to 10% wt/wt.
e) At least one aqueous agent selected from sea water, tap water, distilled water, ice and combinations thereof in a weight ratio of 20 to 90% wt/wt.

A non-limiting example of the sealant composition is:
a) At least one organic or inorganic filler selected from carbon ash, aluminum hydroxide, calcium carbonate, calcium hydroxide, magnesium hydroxide, magnesium carbonate, titanium hydroxide, silica, similar fillers and combinations thereof in a weight ratio of 0.01-10% wt/wt.
b) At least one gelling agent selected from carrageenan, agar agar, hydroxymethylcelluose, hydroxyethyl cellulose, hydroxypropyl cellulose and combinations thereof in a weight ratio of 0 to 30% wt/wt.
c) A coloring agent selected from a water soluble dye, a water insoluble dye, a paint, an oxide, a metal oxide and combinations thereof in a weight ratio of 0 to 1% wt/wt.
d) At least one surfactant selected from an ionic surfactant, an anionic surfactant, a detergent, an edible oil, an inedible oil and combinations thereof in a weight ratio of 0.01 to 20% wt/wt.
e) At least one aqueous agent selected from sea water, tap water, distilled water, ice and combinations thereof in a weight ratio of 20 to 85% wt/wt.

A non-limiting example of composition 118 is:
a) At least one organic or inorganic filler selected from carbon ash, aluminum hydroxide, calcium carbonate, calcium hydroxide, magnesium hydroxide, magnesium carbonate, titanium hydroxide, silica, similar fillers and combinations thereof in a weight ratio of 0.01-10% wt/wt.
b) At least one gelling agent selected from carrageenan, agar agar, hydroxymethylcelluose, hydroxyethyl cellulose, hydroxypropyl cellulose and combinations thereof in a weight ratio of 0 to 30% wt/wt.
c) A coloring agent selected from a water soluble dye, a water insoluble dye, a paint, an oxide, a metal oxide and combinations thereof in a weight ratio of 0 to 1% wt/wt.
d) At least one surfactant selected from an ionic surfactant, an anionic surfactant, a detergent, an edible oil, an inedible oil and combinations thereof in a weight ratio of 0.01 to 20% wt/wt.
e) At least one aqueous agent selected from sea water, tap water, distilled water, ice and combinations thereof in a weight ratio of 20 to 85% wt/wt.
1) Gel pigs are adapted to multi-dimensioned pipes—adaption to variable and changing diameters in situ.
2) Non-abrasive very non-abrasive (in contrast to poly pigs, which may get stuck in a pipeline, induce a reddening of water, induce a change of pH of the water, or may abrade tubicles).
3) Gel pigs of the present invention are to introduce into pipe and to remove from pips providing system flexibility.
4) Gel pigs of the present invention do not normally get stuck in the pipe (better than polymer (solid) pigs) and due to their fluidity, can always be flushed out.
5) The rear pig does not compromise/dislodge/disengage newly formed seals, in contrast to solid pigs.
6) Gel pigs of the present invention are fully flushable (in contrast solid pigs leave debris).
7) A front pig of the present invention allows water to bypass and overtake-allows escape route to prevent/minimize sealant composition dilution.
8) In a two pig system, the rear pig acts differently to the front pig.
9) Pig receiver/retriever for solid pigs is not required for gel pigs.
10) The gel pigs of the present invention are biodegradable.
11) Gel pigs of the present invention require reduced transportation costs—here can be formulated at/near the site of use. Saving on transport costs.

### EXAMPLES

### Example 1

A gel pig is formed according to the following method.
1) Chemical constituents were obtained in accordance with table 1.
2) A gel pig mixture was made by mixing the components of table 1 in a stirred vessel for several (1-30) minutes at ambient temperature and pressure.
3) The resultant gel formed was stored in a closed container in the dark for 0-60 days at room temperature before use.

TABLE 1
Chemical composition of gel pig

| Functional | Example | |
|---|---|---|
| Component | Constituent | Weight percent [%] |
| Hygroscopic | Cellulose, gum, | 1-10 |
| component | gelatin or other | |
| surfactant | Oil or other | 0-8 |
| Base | Aluminum | 0-20 |
| | hydroxide | |
| Particulate | Silica | 0-2 |
| Carrier fluid | Water | 70-95 |
| | Total | 100 |

According to some embodiments, the physical properties of the gel pigs appear as in tables 2 and/or 3.

According to one or more embodiments, hydrophobic solvents are liquid oils originating from vegetable, marine or animal sources. The canola oil exemplified may be replaced by any suitable liquid oil including saturated, unsaturated or polyunsaturated oils. By way of example, the unsaturated oil may be olive oil, corn oil, soybean oil, cottonseed oil, coconut oil, sesame oil, sunflower oil, borage seed oil, syzigium aromaticum oil, hempseed oil, herring oil, cod-liver oil, canola oil, salmon oil, flaxseed oil, wheat germ oil, evening primrose oils or mixtures thereof, in any proportion.

According to one or more embodiments, the silica exemplified may be replaced by a) microsponges, b) silica, c) mineral bodies like zeolite, bentonite, (iii) graphite, including polymers, dendrimers and liposomes, or mixtures thereof, in any proportion.

According to one or more embodiments, the aluminum hydroxide exemplified may be replaced by minerals such as aluminum phosphate and calcium phosphate or mixtures thereof, in any proportion.

According to one or more embodiments, the hydroxyethyl cellulose exemplified may be replaced by any at least one polymeric additive selected from the group consisting of polysaccharides, natural polysaccharides, derivatives thereof, modified polysaccharides, derivatives thereof, starch, dextrin, glycogen, cellulose and chitin, glycosaminoglycans (GAG's), chondroitin sulphate, dermatan sulphate, keratan sulphate, heparan sulphate, heparin, and hyaluronan, amylose and amylopectine, cellulose derivatives, xanthan gum, sodium CMC, methylcellulose, and hydroxyl propyl methyl cellulose or mixtures thereof, in any proportion.

Specific non limiting examples of surfactants are an ionic surfactant, a non-ionic surfactant, a hydrophobic surfactant or mixtures thereof, in any proportion.

Exemplary hygroscopic agents that can be used in accordance with one or more embodiments include, for example, naturally-occurring polymeric materials, such as locust bean gum, sodium alginate, sodium caseinate, egg albumin, gelatin agar, carrageenan gum, sodium alginate, xanthan gum, quince seed extract, tragacanth gum, guar gum, starch, chemically modified starches and the like, semi-synthetic polymeric materials such as cellulose ethers (e.g. hydroxyethyl cellulose, methyl cellulose, carboxymethyl cellulose, hydroxy propylmethyl cellulose), guar gum, hydroxypropyl guar gum, soluble starch, cationic celluloses, cationic guars, and the like, and synthetic polymeric materials, such as carboxyvinyl polymers, polyvinylpyrrolidone, polyvinyl alcohol, polyacrylic acid polymers, polymethacrylic acid polymers, polyvinyl acetate polymers, polyvinyl chloride polymers, polyvinylidene chloride polymers and the like. Mixtures of the above compounds are contemplated.

According to some further embodiments, a base may be selected from sodium hydroxide, magnesium hydroxide, aluminum hydroxide, potassium hydroxide and combinations thereof.

TABLE 2
Physical and Chemical properties of rear gel pig

| | minimum | maximum |
|---|---|---|
| Viscosity cPs | 5 | 10000 |
| Density g/cm³ | 0.8 | 1.2 |

TABLE 3
Physical and Chemical properties of front gel pig

| | minimum | maximum |
|---|---|---|
| Viscosity cPs | 5 | 10000 |
| Density g/cm³ | 0.8 | 1.5 |

The references cited herein teach many principles that are applicable to the present invention. Therefore the full contents of these publications are incorporated by reference herein where appropriate for teachings of additional or alternative details, features and/or technical background.

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

1. A method for curing at one leakage site in a pipeline, the method including
a. locating a leakage at a remote site;
b. deploying a launcher system proximal to said remote site;
c. introducing a pig train into the pipeline from said launcher system, the pig train including;
i) at least one gel pig; and
ii) at least one sealant composition; wherein the at least one gel pig and the at least one sealant composition form said pig train;
d. enabling the pig train to move along the pipeline to a region of the at least one leakage and to seal the at least one leakage.

2. A method according to claim 1, further comprising following the sealing of leakage along the pipeline enabling the pig train to move to a downstream point for extraction of the remaining pig train.

3. A method according to claim 1, further comprising following the sealing of leakage along the pipeline enabling the pig train to stop and reverse its motion back to an upstream point for extraction of the remaining pig train.

4. A method according to claim 1, further comprising transporting said launcher system to said leakage site.

5. A method according to claim 1, wherein said launcher system comprises:
a. at least one input filter;
b. at least one check valve;
c. a pipe manifold configured to feed three flow paths;
d. an outlet to the treated pipe section into which a pig train is launched
e. an outlet to an upstream point for extraction of the remaining pig train
f. an outlet for back pressurizing downstream of the stopped pig train back towards the launcher
g. a launching conduit configured to house a pig train prior to launching; and
h. at least one flow meter.
i. pressure gauges that measure the pressures at the input and output of the launcher.

6. A method according to claim 1, wherein at least part of said pipeline is underground or under water.

7. A method according to claim 1, wherein said leakage site is underground or under water.

8. A method for curing at one leakage site in a pipeline, the method including
a. deploying a launcher system at a remote site; and
b. introducing a pig train into the pipeline from said launcher system, the pig train including;
i) at least one gel pig; and
ii) at least one sealant composition;
wherein the at least one gel pig and the at least one sealant composition form said pig train, thereby enabling the pig train to move along the pipeline to a region of the at least one leakage and to seal the at least one leakage.

9. A method according to claim 1, further comprising following the sealing of leakage along the pipeline enabling the pig train to move to a downstream point for extraction of the remaining pig train.

10. A method according to claim 8, further comprising following the sealing of leakage along the pipeline enabling the pig train to stop and reverse its motion back to an upstream point for extraction of the remaining pig train.

11. A method according to claim 8, further comprising transporting said launcher system to said leakage site.

12. A method according to claim 8, wherein said launcher system comprises:
a. at least one input filter;
b. at least one check valve;
c. a pipe manifold configured to feed three flow paths;
d. an outlet to the treated pipe section into which a pig train is launched
e. an outlet to an upstream point for extraction of the remaining pig train
f. an outlet for back pressurizing downstream of the stopped pig train back towards the launcher
g. a launching conduit configured to house a pig train prior to launching; and
h. at least one flow meter.
i. pressure gauges that measure the pressures at the input and output of the launcher.

13. A method according to claim 8, wherein said pig train is a gel pig train.

14. A method according to claim 8, wherein said pig train pig comprises includes one gel pig and the at least one sealant composition includes one sealant composition.

15. (canceled)

16. A method for curing at one leakage site in a pipeline, according to claim 1, the method further comprising:
a. Treated Pipe Pressurization—Pressurizing the to-be-treated-pipe-section from the Launcher to the designated pressure;
b. Leakage Measurement Test—Reading the digital flow meter and roto meter to determine the level of flow reflecting the level of aggregated leakage in the to-be-treated-pipe-section;
c. In-Situ Materials Preparation—Mixing, blending, pouring and otherwise preparing prepackaged components that form the basis the materials comprising the pig train;
d. Loading the Launcher—Tightly loading the launching tube with the materials in the proper order to form the pig train;
e. Setting Drive Flow—Opening a discharge valve downstream of the treated-pipe-section to determine the level of flow of water and therefore setting the speed of the pig train;
f. Launching—Creating a flow path to include the pig train therefore inducing its launch from the launching tube into the treated-pipe-section;
g. Driving Pig Train—Monitoring the drive flow and when it drops due to a leak seal increasing it back to the drive flow at launch;
h. Retrieving Pig Train—At the end of its path allowing the pig train to be extracted downstream from the treated-pipe-section; and
i. Leakage Measurement Test—Reading the digital flow meter and roto meter to determine the level of flow reflecting the residual level of aggregated leakage in the treated-pipe-section.

17. A launcher apparatus, adapted for local deployment and use to seal a local leakage in a pipeline network, the launcher apparatus comprising:
a. at least one input filter;
b. at least one check valve;
c. a pipe manifold configured to feed three flow paths;
d. an outlet to the treated pipe section into which a pig train is launched;
e. an outlet to an upstream point for extraction of the remaining pig train;
f. an outlet for back pressurizing downstream of the stopped pig train back towards the launcher;
g. a launching conduit configured to house a pig train prior to launching; at least one flow meter; and
h. pressure gauges that measure the pressures at the input and output of the launcher.

18. A launcher system for launching gel pig trains for sealing pipelines at a location of a leakage, the launcher system comprising the launcher apparatus according to claim 17, and further comprising:
a launcher apparatus carrier module, wherein the carrier module is configured to receive the launcher apparatus and adapted for human transport of the system to a remote site.

19. A launcher apparatus according to claim 17, for launching pig trains for sealing pipelines at a location of a leakage, the launcher apparatus further comprising:
a. a conduit arrangement comprising:
i. an inlet module for receiving a pig train;
ii. an outlet module for releasing said pig train;
iii. a pump;
iv. a pressure gauge;
v. connector conduits fluidly connected between said inlet module and said outlet module; and
vi. valves for controlling at least one of a velocity and a head pressure of said pig train exiting said outlet module.

20. A launcher apparatus for launching pig trains for sealing pipelines at a location of a leakage according to claim 17, the launcher apparatus further comprising:
a) a conduit arrangement comprising:
i. an inlet module for receiving a pig train;
ii. an outlet module for releasing said pig train;
iii. a pump;
iv. a pressure gauge;
v. three connector conduits fluidly connected generally perpendicularly between said inlet module and said outlet module, wherein said outlet module is disposed generally in parallel to said inlet module; and
vi. valves for controlling at least one of a velocity and a head pressure of said pig train exiting said outlet module.
